(19) United States
(12) Patent Application Publication
(10) Pub. No.: US 2016/0140297 A1
(43) Pub. Date: May 19, 2016

(54) Clinical information management system

(71) Applicant: Howard Wisnicki, Las Vegas, NV (US)

(72) Inventor: Howard Wisnicki, Las Vegas, NV (US)

(21) Appl. No.: 14/756,811

(22) Filed: Oct. 16, 2015

Related U.S. Application Data
(60) Provisional application No. 62/122,434, filed on Oct. 20, 2014.

(51) Int. Cl. G06F 19/00

(52) U.S. Cl. CPC G06F 19/322; G06F 19/363; G06F 19/327

(57) ABSTRACT

The present invention is generally directed to an information management system, where the managed information relates to past, current and future medical services rendered to a patient. In one aspect, the present invention provides a method of collecting and transmitting information related to a physician's revenue. The method comprises the steps of: 1) collecting information from a patient using a dialogue box presented to a patient through a graphical user interface displayed on an electronic device, where the information includes answers to one or more questions, and where the questions are directed to a particular medical area (e.g., ophthalmology), and where the questions are leading, and where the answers can be used by a physician to increase revenue; 2) transmitting the information to a physician.

The present Application claims the benefit of U.S. Provisional Patent Application No. 62/122,434, entitled “Clinical Information Management System,” filed Oct. 20, 2014, which is incorporated herein by reference in its entirety.

### FIELD OF THE INVENTION

The present invention is generally directed to an information management system, where the managed information relates to past, current and future medical services rendered to a patient.

### BACKGROUND OF THE INVENTION

Information management systems related to patient medical services have been reported. For instance, U.S. Pat. No. 7,286,997, entitled “Internet-Based Customizable Clinical Information System” discusses the following: “An Internet-based, or Web-based, customizable clinical (patients' records and care) information system (“CIS”) is provided. More specifically, the clinical information system is Web/Internet based, whether it utilizes a browser-type user interface or a distributed application-type user interface; the clinical information system may include automatic disease staging and associated treatment planning and/or scheduling; the clinical information system may track certain events/submissions and sort such events/submissions into a physician's in-box for on-line approval by the physician, where such approval causes the event/submission to become an addendum to the patient's record; the clinical information system may be customizable by an administrator; the clinical information system may establish, and make available for on-line review and approval, patient care or standing orders over a weekend; the clinical information system may utilize patients' photographs to ensure accurate identification and proper treatment; and the clinical information system may create and store an audit trail record for all significant events.” Abstract.

Despite reports such as the above, there is still a need for new information management systems, where the managed information relates to past, current and future medical services rendered to a patient.

### BRIEF DESCRIPTION OF THE DRAWINGS

FIG. 1 illustrates an exemplary network architecture in which embodiments of the invention may operate.

FIG. 2 illustrates a dialogue box, where a patient can search fields related to physician care.

FIG. 3 illustrates a box, where a patient can schedule appointments with a physician, hospital, or testing service.

FIG. 4 illustrates a box, where a patient can enter a tutorial including frequently asked questions and answers regarding a specialty area of interest.

FIG. 5 illustrates a dialogue box, where questions related to a patient's interests are presented for answer.

FIG. 6 illustrates a management report for a physician, where the physician can monitor revenue per patient.

FIG. 7 illustrates an email communication in which a patient is reminded of a hospital appointment.

FIG. 8 illustrates a physician report for a hospital administrator, where the administrator can monitor physican referrals.

### SUMMARY OF THE INVENTION

The present invention is generally directed to an information management system, where the managed information relates to past, current and future medical services rendered to a patient.

In one aspect, the present invention provides a method of collecting and transmitting information related to a physician's revenue. The method comprises the steps of: 1) collecting information from a patient using a dialogue box presented to a patient through a graphical user interface displayed on an electronic device, where the information includes answers to one or more questions, and where the questions are directed to a particular medical area (e.g., ophthalmology), and where the questions are leading, and where the answers can be used by a physician to increase revenue; 2) transmitting the information to a physician.

In another aspect, the present invention provides a method for increasing patient satisfaction. The method comprises the steps of: 1) providing a first dialogue box presented to a patient through a graphical user interface displayed on an electronic device, where the dialogue box allows the patient to search for a physician using a number of parameters, and where the parameters comprise location, training and experience and office hours; 2) providing a second dialogue box presented to the patient through a graphical user interface, where the dialogue box allows the patient to make an appointment with a physician found through use of the first dialogue box, and where the appointment can be made 24 hours/day, 7 days/week and 365 days/year; 3) thereby increasing patient satisfaction.

In another aspect, the present invention provides a method of reducing the number of re-admission denials under the “Obamacare” 30 day rule. That rule states that patients admitted with the same diagnosis within 30 days of hospital discharge will be denied third party patient reimbursement. The method comprises the steps of: 1) identifying at least one patient who has been admitted to a hospital; 2) scheduling at least one follow-up visit with a physician using a dialogue box presented to a hospital administrator through a graphical user interface; 3) sending a reminder regarding the follow-up visit to the patient; 4) thereby reducing the number of re-admission denials under the 30 day rule.

In another aspect, the present invention provides a method of tracking a patient's course through a healthcare system. The method comprises the steps of: 1) tracking visits of a patient to medical professionals through information submitted to a system through a dialogue box presented through a graphical user interface; 2) analyzing the tracked visits to determine one or more physicians treating the patient and one or more other physicians, hospitals or testing centers visited by the patient to provide data; 3) presenting the data as a report through a graphical user interface to a user.

### DETAILED DESCRIPTION OF THE INVENTION

There are existing scheduling systems. The present invention distinguishes itself from such systems at least with respect to the following: the type of information collected that is related to scheduling; the analysis of the information; unique tools and reports generated by a user in view of the information.

Hospitals are continuously searching for ways to drive business (i.e., patients) into their physician's offices. This ultimately leads to increased business and revenue for the hospital in terms of patient referrals for tests, outpatient procedures, surgeries and inpatient admissions. The present invention cultivates this business potential by allowing prospective patients to review the background and credentials of physicians in their community. This review allows a patient to make an informed decision and to conveniently schedule physician appointments on-line. Hospitals may also use this system for scheduling outpatient volume for hospital-based services—e.g., X-ray, laboratory, MRI, physical therapy, radiation therapy, infusion therapy, etc.

For the past several years, Fraud and Abuse and Stark laws have eliminated many ways in which hospitals and physicians can create reciprocal loyalty. The present invention contributes toward enhancing relationships among physicians, hospitals and patients. Perhaps more importantly, it will increase the revenue of physicians through application of proprietary data review methods as well as groundbreaking management tools.

The present invention is described in more detail below in reference to the figures.

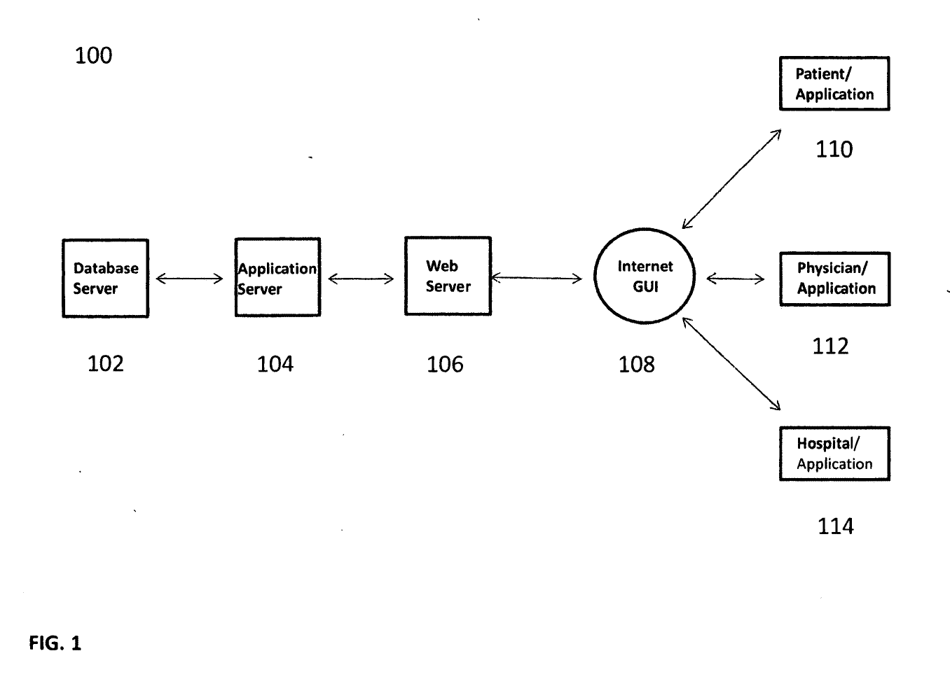

FIG. 1 is a block diagram of an exemplary network architecture 100, in which embodiments of the present invention may operate. The network architecture 100 is typically a multi-tiered client/server information management system. Such a system includes a database server 102, an application server 104 and a web server 106. A graphical user interface is presented through the interne 108, where users such as patients 110, physicians 112 and hospitals 114 interact with the system. The server functions may be hosted on the same physical hardware or may be distributed on multiple machines for scalability. Users employ multiple device dependent applications, typically including applications such as a device independent website, an iOS application, an Android application and a kiosk for use in public areas.

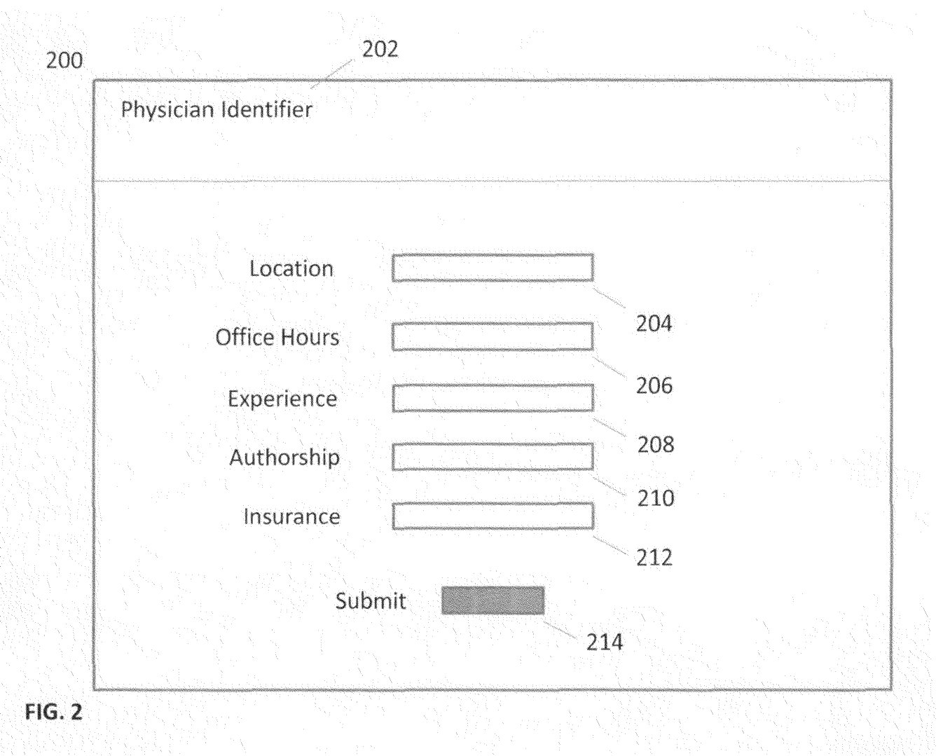

FIG. 2 illustrates a dialogue box 200, shown as Physician Identifier 202, where a patient can search fields related to physician care. For instance, a user can search a physician's location 204, office hours 206, years in practice (experience) 208, authorship of books or other publications 210, insurance type accepted 212, etc. A user can submit a search within a particular field using submit button 214. By allowing a user to review the background and credentials of physicians in their community, he can make an informed selection.

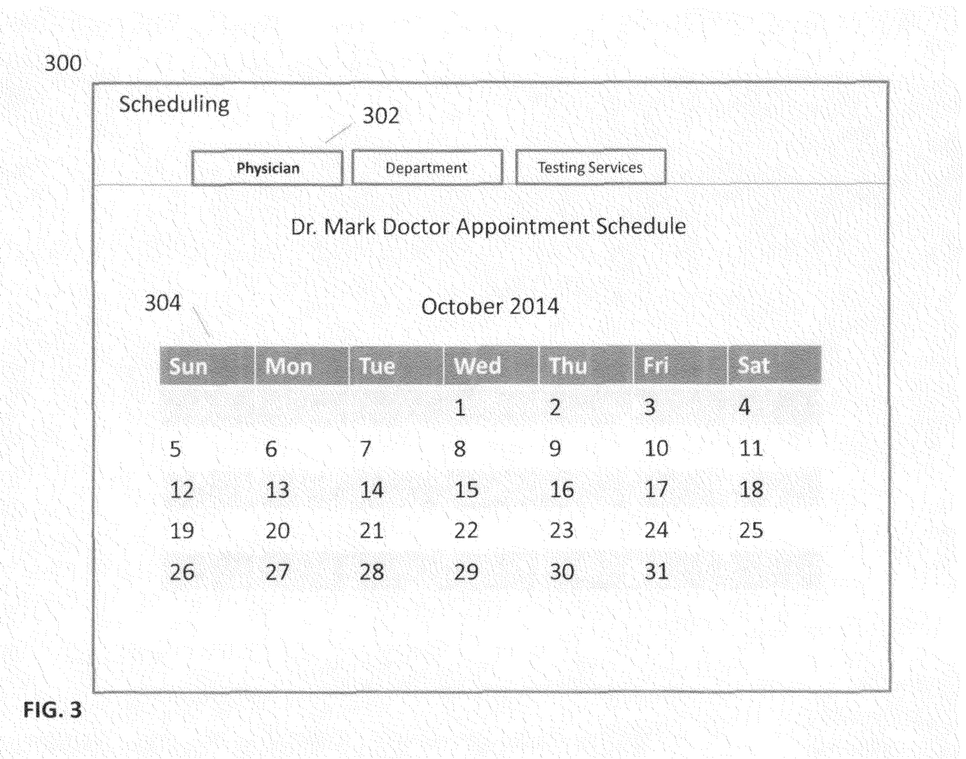

Once a patient has selected a physician, he can make an appointment with the physician (or associated hospital or testing service) using an embodiment of the present invention. FIG. 3 illustrates a box 300, where a patient can schedule appointments with the physician. The box, as shown for purposes of example, includes tabs 302 indicating the type of appointment to be made and a calendar 304 on which to make the appointments. A patient can make appointments through this system 24 hours/day, 7 days/week and 365 days/year, thus eliminating what can be a very frustrating process associated with physician and hospital scheduling.

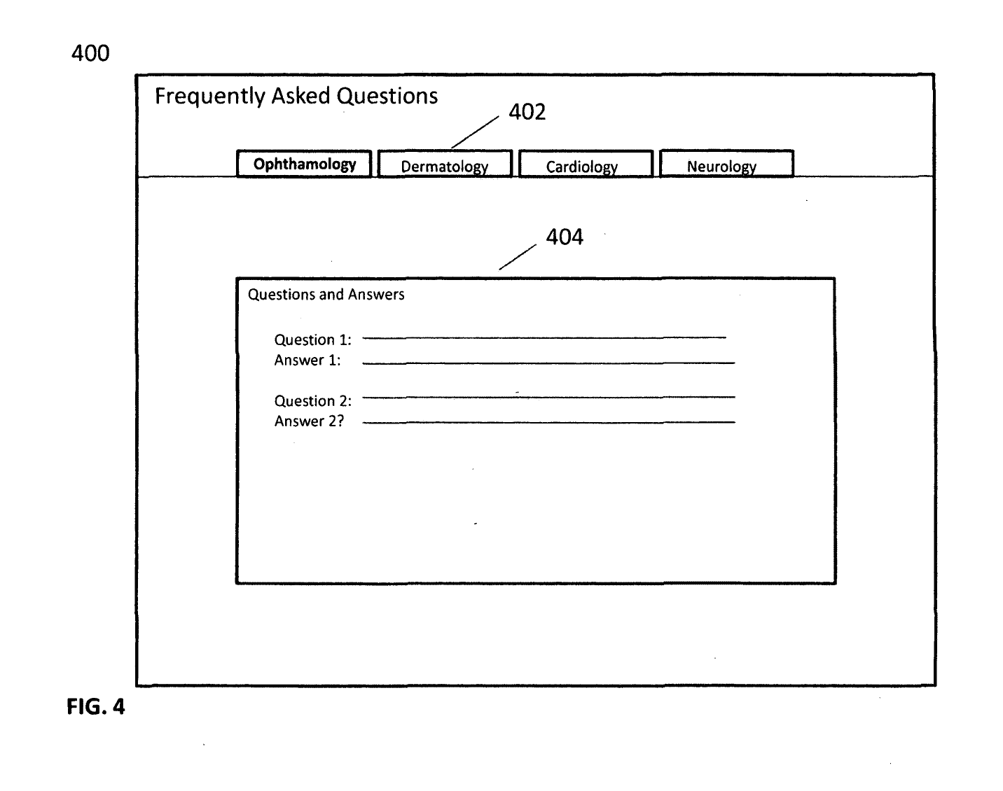

FIG. 4 illustrates a box 400, where a patient can enter a tutorial including frequently asked questions and answers regarding a specialty area of interest. The box, as shown for purposes of example, includes tabs 402 indicating the specialty area of interest and a set of frequently asked questions 404. Frequently asked questions 404 are designed to aid the patient in making decisions regarding medical care.

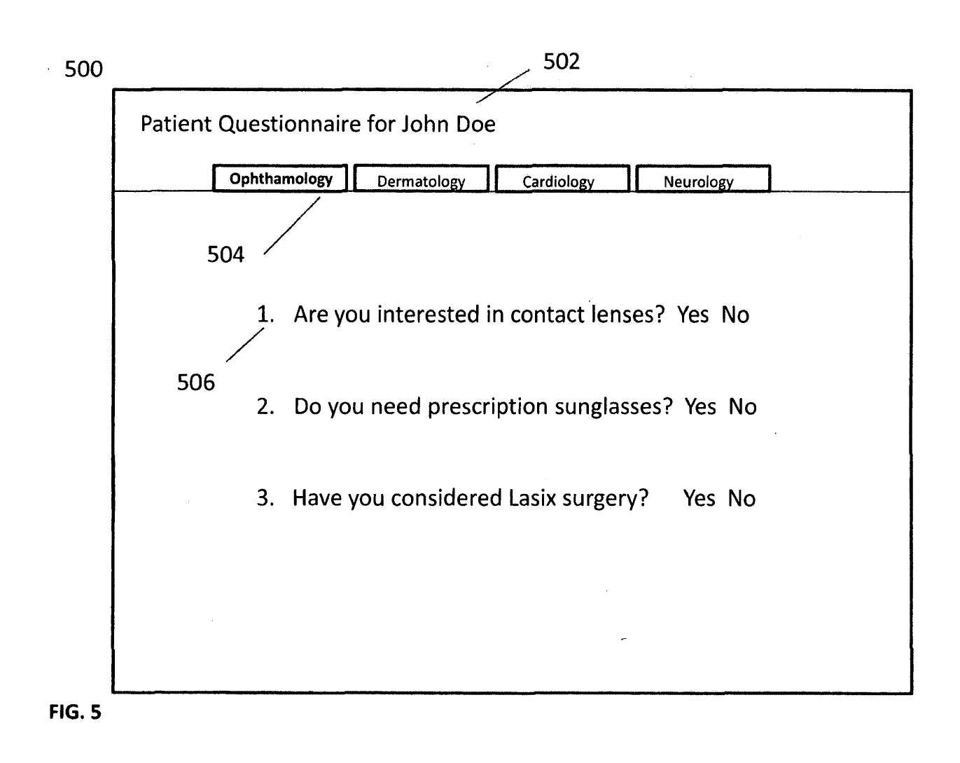

Patients interacting with an embodiment of the present invention are presented with a questionnaire, asking them a series of customized leading questions designed to improve their healthcare and produce additional revenue for a physician and/or hospital. FIG. 5 illustrates a dialogue box 500, having, for example, a header including the name of the patient 502.

FIG. 5 illustrates a dialogue box 500, where questions related to a patient's interests are presented for answer. As shown for example, dialogue box 500 includes a header identifying the box as a questionnaire for a particular patient 502. Tabs 504 allow the patient to select areas that interest him. Customized, leading questions 506 designed to improve a patient's healthcare, and to provide additional revenue to physicians and hospitals, are presented to the patient. For instance, an ophthalmologist's patients may be asked the following types of questions: Are you interested in contact lenses? Do you need prescription sunglasses? Have you ever considered Lasix surgery? Do you have diabetes? Additional questions related to important follow-up care are then provided.

Answers to the questions of dialogue box 500 are automatically transmitted to a physician, who now has the patient's selection of possible elective care. This information serves as a “laundry list” for the physician to discuss elective care with the patient. As such, it benefits both the healthcare status of the patient as well as the physician's revenue stream.

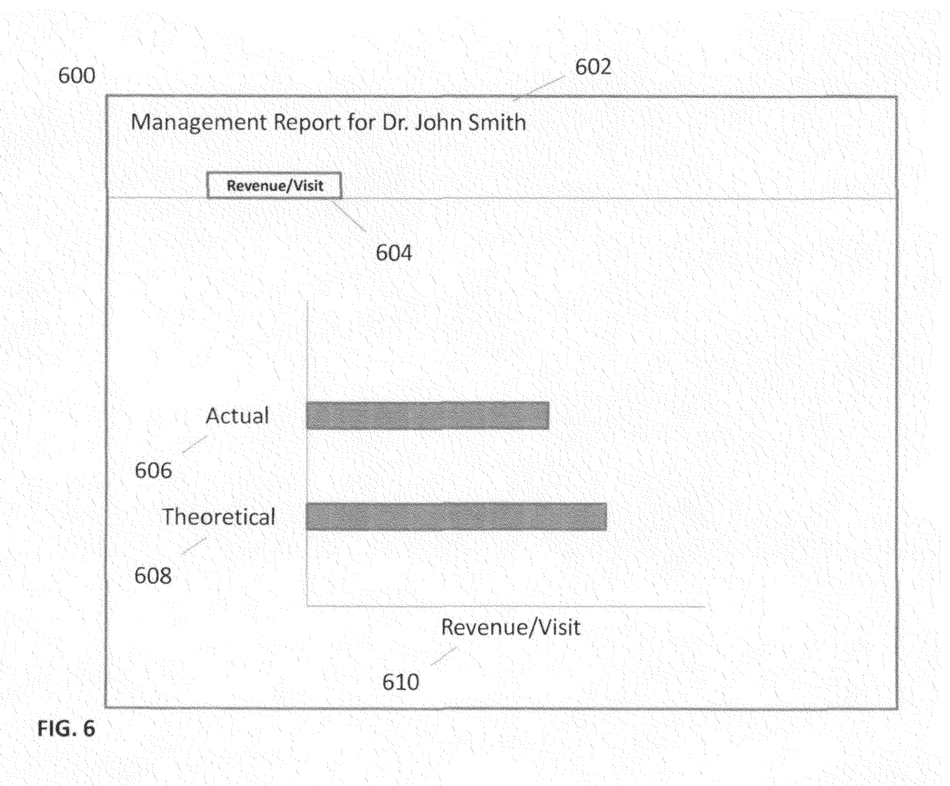

The system of the present invention can provide a management report for a physician. FIG. 6, for example, illustrates one such report, where the physician can monitor revenue per patient. As shown for illustration, management report 600 includes a header 602 noting the name of the physician requesting the report. A tab 604 indicates the type of report generated, and a bar graph 606 plots revenue per visit (although any other type of graph, expression or statement may due). The marginal revenue the physician receives by virtue of using the present invention is shown as well as the theoretical revenue one should have received.

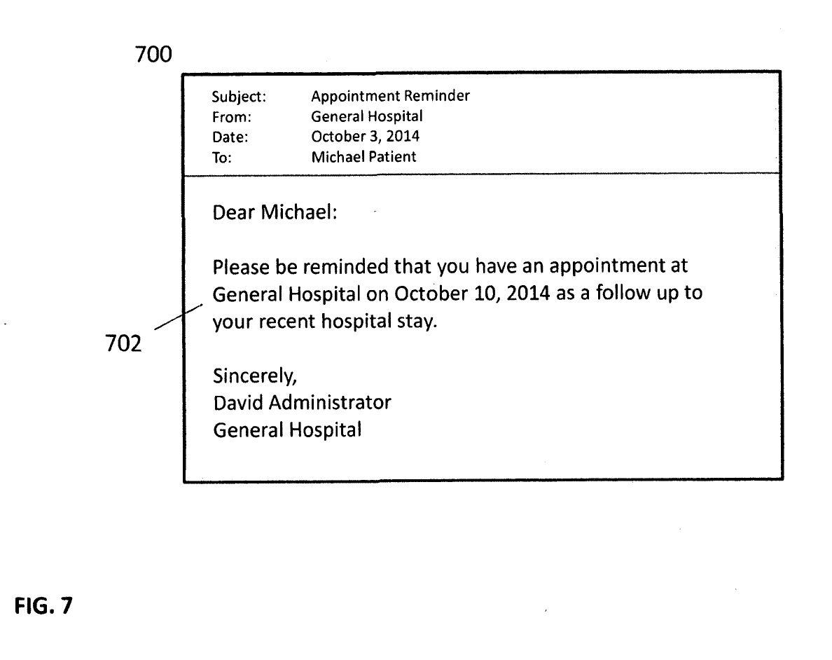

Post-discharge clinic and physician visits can improve a patient's recovery from a prior condition that necessitated hospital admission. This is especially true for conditions such as diabetes, heart disease, pulmonary ailments. The system of the present invention sends periodic reminders to a patient to attend post-discharge sessions/appointments, thereby increasing the probability that one or more follow-up visits will occur. FIG. 7 illustrates an email communication 700 in which a patient receives a reminder 702 of a hospital appointment.

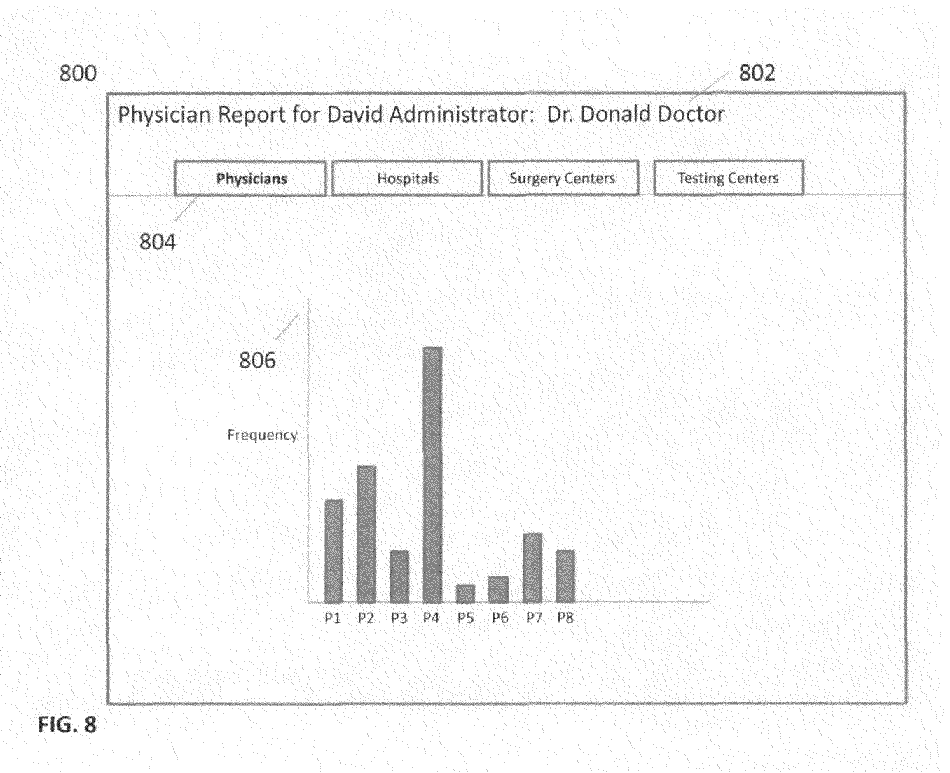

The present system will uniquely track a patient's course through the healthcare system. It will inform a hospital, among other things, as to which physicians, hospitals, surgery centers or ancillary testing centers a physician is making referrals. For example, FIG. 8 illustrates a physician report 800 for a hospital administrator, where the administrator can monitor physician referrals. As shown, report 800 includes a header 802 and a set of tabs 804 that allow one to select the type of referral (e.g., physician, hospital, surgery center, testing center) to be monitored. A representation of referral frequency 806—in this illustration a bar graph—allows an administrator to rapidly access the nature of a physician's referrals.

In one aspect, the present invention provides a method of collecting and transmitting information related to a physician's revenue. The method comprises the steps of: 1) collecting information from a patient using a dialogue box presented to a patient through a graphical user interface displayed on an electronic device, where the information includes answers to one or more questions, and where the questions are directed to a particular medical area (e.g., ophthalmology), and where the questions are leading, and where the answers can be used by a physician to increase revenue; 2) transmitting the information to a physician. The physician can then use the transmitted information to increase his revenue.

In certain cases, the patient answers can be used to increase the physician's revenue by at least 5 percent over the course of a year. In other cases, the answers can be used to increase the physician's revenue by at least 10 percent, 15 percent, 20 percent, 30 percent, 40 percent or 50 percent over the course of a year.

In another aspect, the present invention provides a method for increasing patient satisfaction. The method comprises the steps of: 1) providing a first dialogue box presented to a patient through a graphical user interface displayed on an electronic device, where the dialogue box allows the patient to search for a physician using a number of parameters, and where the parameters comprise location, training and experience and office hours; 2) providing a second dialogue box presented to the patient through a graphical user interface, where the dialogue box allows the patient to make an appointment with a physician found through use of the first dialogue box, and where the appointment can be made 24 hours/day, 7 days/week and 365 days/year; 3) thereby increasing patient satisfaction.

In certain cases, patient satisfaction can be increased at least 5 percent using the method discussed above, as measured by a customer satisfaction score (“CSAT”). CSAT is often determined by a single question in a follow-up survey, such as: “How would you rate your overall satisfaction with the service your received?” The survey is often graded on a scale of one to five, with a score of one representing “very dissatisfied” and five representing “very satisfied”. Surveys are averaged for a composite CSAT score. In other cases, patient satisfaction can be increased at least 7.5 percent, 10 percent, 12.5 percent, 15 percent, 20 percent or 25 percent using the method discussed above.

In another aspect, the present invention provides a method of reducing the number of re-admission denials under the “Obamacare” 30 day rule. That rule states that patients admitted with the same diagnosis within 30 days of hospital discharge will be denied third party patient reimbursement. The method comprises the steps of: 1) identifying at least one patient who has been admitted to a hospital; 2) scheduling at least one follow-up visit with a physician using a dialogue box presented to a hospital administrator through a graphical user interface; 3) sending a reminder regarding the follow-up visit to the patient; 4) thereby reducing the number of re-admission denials under the 30 day rule.

In certain cases the number of re-admission denials is reduced by at least 5 percent. In other cases, the number of re-admission denials is reduced by at last 10 percent, 20, percent, 30 percent, 40 percent or 50 percent.

In another aspect, the present invention provides a method of tracking a patient's course through a healthcare system. The method comprises the steps of: 1) tracking visits of a patient to medical professionals through information submitted to a system through a dialogue box presented through a graphical user interface; 2) analyzing the tracked visits to determine one or more physicians treating the patient and one or more other physicians, hospitals or testing centers visited by the patient to provide data; 3) presenting the data as a report through a graphical user interface to a user. This information can be used to improve the relationship between a physician and a hospital.

In certain cases, the relationship between a physician and a hospital is improved at least 5 percent. Improvement is determined by the number of additional referrals received by the hospital from the physician over the time period of a year (as compared to the number of referrals the previous year). In other cases, the relationship is improved at least 10 percent, 20 percent, 30 percent, 40 percent or 50 percent.

By policy and practice, the present invention is carried out in such a way that it is fully compliant with all of the components of the Health Insurance Portability and Accountability Act of 1996, Public Law 104-191 (“HIPAA”), as set forth in 45 CFR Parts 160 and 164, and as amended by the Health Information Technology for Economic and Clinical Health Act, Public Law 111-5 (“HITECH”) and the Final HIPAA Omnibus Rule as published by the Department of Health and Human Services. These combined regulations comprise the HIPAA and HITECH Privacy and Security Rules, which are taken seriously and govern policies and practices related to this invention.

1. A method of collecting and transmitting information related to a physician's revenue, wherein the method comprises the steps of: 1) collecting information from a patient using a dialogue box presented to a patient through a graphical user interface displayed on an electronic device, where the information includes answers to one or more questions, and where the questions are directed to a particular medical area, and where the questions are leading, and where the answers can be used by a physician to increase revenue; 2) transmitting the information to a physician.

2. The method according to claim 1, wherein the answers can be used by a physician to increase revenue by at least 10 percent over the course of a year.

3. The method according to claim 2, wherein the answers can be used by a physician to increase revenue by at least 20 percent over the course of a year.

4. A method for increasing patient satisfaction, wherein the method comprises the steps of: 1) providing a first dialogue box presented to a patient through a graphical user interface displayed on an electronic device, where the dialogue box allows the patient to search for a physician using a number of parameters, and where the parameters comprise location, training and experience and office hours; 2) providing a second dialogue box presented to the patient through a graphical user interface, where the dialogue box allows the patient to make an appointment with a physician found through use of the first dialogue box, and where the appointment can be made 24 hours/day, 7 days/week and 365 days/year; 3) thereby increasing patient satisfaction.

5. The method according to claim 4, wherein patient satisfaction is increased at least 7.5 percent as measured by a customer satisfaction score.

6. The method according to claim 4, wherein patient satisfaction is increased at least 15 percent as measured by a customer satisfaction score.

7. A method of reducing the number of re-admission denials under the “Obamacare” 30 day rule, wherein the method comprises the steps of: 1) identifying at least one patient who has been admitted to a hospital; 2) scheduling at least one follow-up visit with a physician using a dialogue box presented to a hospital administrator through a graphical user interface; 3) sending a reminder regarding the follow-up visit to the patient; 4) thereby reducing the number of re-admission denials under the 30 day rule.

8. The method according to claim 7, wherein the number of re-admission denials under the 30 day rule is reduced by at least 10 percent.

9. The method according to claim 8, wherein the number of re-admission denials under the 30 day rule is reduced by at least 20 percent.

10. A method of tracking a patient's course through a healthcare system, wherein the method comprises the steps of: 1) tracking visits of a patient to medical professionals through information submitted to a system through a dialogue box presented through a graphical user interface; 2) analyzing the tracked visits to determine one or more physicians treating the patient and one or more other physicians, hospitals or testing centers visited by the patient to provide data; 3) presenting the data as a report through a graphical user interface to a user.

11. The method according to claim 10, wherein the method improves a relationship between a patient and a physician as determined by the number of additional referrals received by the hospital from the physician over a time period of a year, wherein the relationship is improved at least 10 percent.

12. The method according to claim 11, wherein the relationship is improved at least 20 percent.
